(19) United States
(12) Patent Application Publication
(10) Pub. No.: US 2004/0050137 A1
(43) Pub. Date: Mar. 18, 2004

(54) Carbon monoxide detector tester and method of using tester

(76) Inventor: Rex Hoppenworth, Marysville, MI (US)

Correspondence Address: Arnold S. Weintraub, Plunkett & Cooney, P.C., Suite 3000, 38505 Woodward, Bloomfield Hills, MI, 48304, US

(21) Appl. No.: 10/167,191

(22) Filed: Jun. 11, 2002

Related U.S. Application Data
(60) Provisional application No. 60/297,734, filed on Jun. 11, 2001.

(51) Int. Cl. G01N 27/00

(52) U.S. Cl. 73/1.06; 73/23.2

(57) ABSTRACT

The present invention is directed to a carbon monoxide detector tester and method for using the carbon monoxide detector tester to determine the operability of a carbon monoxide detector. The tester comprises a closable box adapted to receive and house a carbon monoxide detector and a carbon monoxide emitting material. In use, the closable box is opened and the carbon monoxide detector and carbon monoxide emitting material are inserted within. The carbon monoxide emitting material is ignited and the box is closed. A properly functioning carbon monoxide detector will then sound an alarm indicating a properly functioning detector whereas an improperly functioning detector will not sound an alarm, thus indicating a not properly functioning detector.

### CROSS-REFERENCE TO RELATED APPLICATIONS

This is a completion Patent Application and under 35 USC Section 119 (e) claims a priority date of Jun. 11, 2001 from co-pending U.S. Provisional Patent Application Serial No. 60/297,734, the disclosure of which is incorporated by reference.

### BACKGROUND OF THE INVENTION

1. Field of the Invention

The present invention is directed to a carbon monoxide detector tester and method for determining the operability of a carbon monoxide detector.

2. Description of Prior Art

Carbon monoxide detectors are used to detect the presence of carbon monoxide gas in the air and to signal an alarm when the carbon monoxide gas level in the air reaches a dangerous level. Upon detecting a carbon monoxide detector alarm, a person breathing the carbon monoxide filled air is put on notice that there exist dangerous levels of carbon monoxide in the air. The person may immediately leave the area upon detecting the alarm. However, if the carbon monoxide detector is not functioning properly, then no alarm will signal and thus, a person may be exposed to dangerous levels of carbon monoxide gas without being aware of such levels. Therefore, a device that can determine whether a carbon monoxide detector is properly functioning is both necessary and can prove to be life saving.

The three types of known carbon monoxide detectors are color metric, metal oxide, and electrochemical. Each type of detector has a different means for detecting carbon monoxide.

Additionally, there are several known carbon monoxide detector testers and methods of using those testers to determine whether a carbon monoxide detector is functioning properly. One tester made by Home Safeguard Industries Inc. of Malibu, Calif. comprises a tablet that when moistened, releases a hydrogen derivative gas, similar in nature to carbon monoxide. Upon exposing the hydrogen derivative gas to the carbon monoxide detector, a properly functioning carbon monoxide detector capable of detecting such a hydrogen derivative gas will sound an alarm. If an alarm is not sounded, then the carbon monoxide detector capable of detecting such a hydrogen derivative gas is presumed defective. However, only one or two carbon monoxide detectors are capable of detecting such a hydrogen derivative gas. Therefore, this tester does not adequately test the operability of many known carbon monoxide detectors.

Another type of known carbon monoxide detector tester made by Robert Elliott Enterprises of Aurora, Ontario Canada comprises a clear plastic bag for storing a carbon monoxide detector and a glass vile containing carbon monoxide gas. The method for using this tester to detect the operability of a carbon monoxide detector includes the steps of (1) placing the carbon monoxide detector and carbon monoxide filled glass vile into the plastic bag, (2) sealing the bag with a twist tie, and (3) breaking the glass vile inside the bag to expose the carbon monoxide gas to the carbon monoxide tester.

A properly functioning carbon monoxide detector will sound an alarm once the vile is broken into pieces and the carbon monoxide is exposed to the carbon monoxide detector. If no alarm is sounded, then the carbon monoxide detector is presumed defective. A user of this tester must be careful not to perforate the bag with the sharp glass pieces to prevent the carbon monoxide gas from escaping the bag and voiding the test. In addition, the user must be careful in handling the broken glass vile to avoid being hurt.

Another carbon monoxide detector tester called the Detectagas Test Kit made by the English company SF Detection comprises a flexible vinyl material having an elastic edge enclosing a drawstring. The elastic edge is then placed around a carbon monoxide detector and the drawstring is drawn tight around the detector forming a bag having a small opening formed by the drawn draw string. It is necessary to tightly draw the drawstring to enclose the carbon monoxide detector to prevent the detector from being exposed to air outside of the bag. The tester further comprises a plastic tube having one end affixed to the opening within the bag and one end affixed to a can of compressed air to direct communication of the compressed air into the bag. The plastic tube is inserted within the bag opening once the drawstring has been drawn. In operation, a user depresses the can of compressed air to communicate flow of the compressed air from the can into the bag. A properly functioning carbon monoxide detector will sound an alarm upon receiving the compressed air. If no alarm sounds, the carbon monoxide detector is presumed defective. A new can of compressed air must be used for each subsequent test performed.

### SUMMARY OF THE INVENTION

The present invention, to address the above-stated problems in others, as is detailed hereinafter, enables an improved carbon monoxide detector tester for use in detecting whether a carbon monoxide detector is properly functioning.

The carbon monoxide detector tester of the present invention generally comprises:

(a) a bottom member, the bottom member having:

(i) a first side wall;

(ii) a first bottom wall;

(b) a top member, the top member adapted to mate with the bottom member, the bottom member matingly connects to the top member;

(c) means for storing a carbon monoxide detector within the bottom member; and

(d) means for storing a carbon monoxide emitting material within the bottom member.

The first side wall of the bottom member and the first bottom wall of the bottom member cooperate to form a first storage compartment, the first storage compartment defining means for storing a carbon monoxide detector within the bottom member and the means for storing a carbon monoxide emitting material within the bottom member.

Additionally, the present invention further comprises a method of using the carbon monoxide detector tester of the present invention. This method comprises the steps of:

(a) opening a carbon monoxide detector tester to receive a carbon monoxide detector and a carbon monoxide emitting material;

(b) removably placing a carbon monoxide detector and a carbon monoxide emitting material within a first storage compartment of the opened carbon monoxide detector tester;

(c) igniting the carbon monoxide emitting material to allow the carbon monoxide emitting material to emit carbon monoxide;

(d) securely enclosing the carbon monoxide detector and the carbon monoxide emitting material to allow the carbon monoxide detector to receive the carbon monoxide; and

(e) detecting an alarm signaled by the carbon monoxide detector when the carbon monoxide detector receives the carbon monoxide.

The improved carbon monoxide detector tester and the method of use accommodate any type of carbon monoxide detector currently available on the market. The carbon monoxide detector tester hereof is capable of repeated uses and is both easy and safe to use.

The various features, advantages and other uses of the present invention will become more apparent by referring to the detailed description and drawing in which:

### BRIEF DESCRIPTION OF THE DRAWINGS

FIG. 1 is a perspective view of a first embodiment of a carbon monoxide detector tester in accordance with the present invention;

FIG. 2 is a perspective view of a second embodiment of a carbon monoxide detector tester in accordance with the present invention;

FIG. 3 is a perspective view of a second embodiment of a carbon monoxide detector tester showing the carbon monoxide detector tester in its sealed position;

FIG. 4 is a perspective view of a third embodiment of a carbon monoxide detector tester in accordance with the present invention;

FIG. 5 is a perspective view of a forth embodiment of a carbon monoxide detector tester in accordance with the present invention;

FIG. 6 is a perspective view of a fifth embodiment of a carbon monoxide detector tester in accordance with the present invention;

FIG. 7 is a perspective view of a sixth embodiment of a carbon monoxide detector tester in accordance with the present invention;

FIG. 8 is a side view of a removable rear access panel in accordance with a sixth embodiment of the present invention.

FIG. 9 is a side view of the carbon monoxide detector shown in FIG. 7.

### DESCRIPTION OF THE PREFERRED EMBODIMENT

Referring now to the drawings, a carbon monoxide detector tester generally comprises: (a) a bottom member, the bottom member having i) a first side wall, and (ii) a first bottom wall; (b) a top member, the top member adapted to mate with the bottom member; (c) means for storing a carbon monoxide detector; (d) means for storing a carbon monoxide emitting material, wherein the first side wall and the first bottom wall of the bottom member cooperate to form a first storage compartment, the first storage compartment defining the carbon monoxide detector storage means and the carbon monoxide emitting material storage means.

Both the bottom member and the top member may be made from a material such as plastic. A plastic material is desirable because of its low cost and because of the ease with which a mold can be modified to accommodate any carbon monoxide detector, such as a detector designed to plug into an electrical outlet, etc. However, other materials such as metal may also be used to make the tester provided that the material used is not so thick as to block sound.

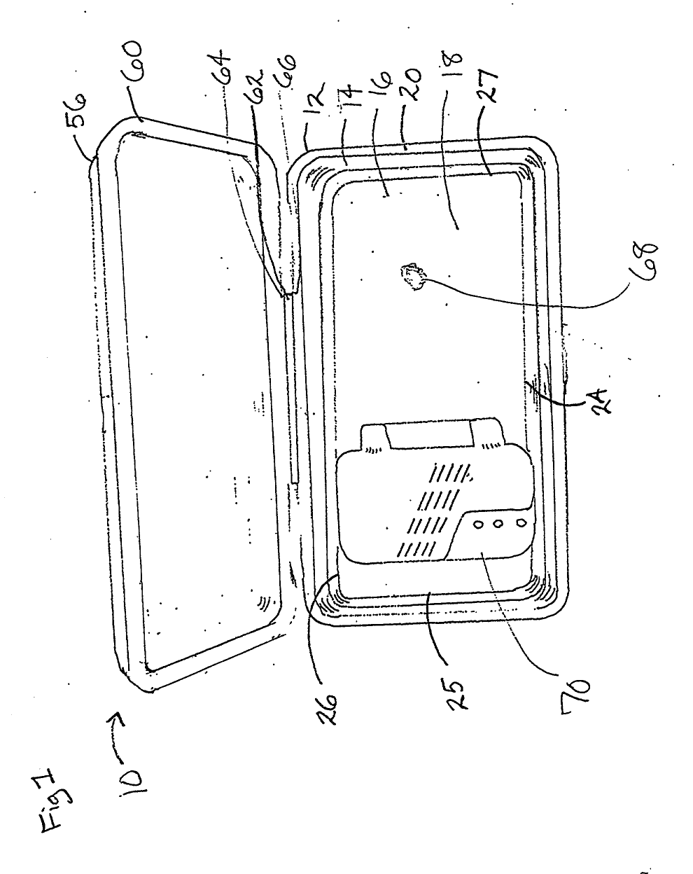

As shown in FIG. 1, the tester 10 is formed by a bottom member 12, a top member 56, and a hinge member 62, the members being integral with one another and forming a unitary clamshell structure. The top member 56 is adapted to mate with the bottom member 12 and both cooperate to form a box having a rectangular shape when so mated. The side wall 14 and the bottom wall 16 cooperate to form a storage compartment 18 for storing both a carbon monoxide detector 70 and a carbon monoxide emitting material 68.

Preferably, a suitable carbon emitting material 68 is charcoal or incense, or any other suitable material that emits carbon monoxide when ignited, as known by those skilled in the art.

The rectangular shape is preferred because it closely matches the design of most carbon monoxide detectors and therefore can easily provide a housing for disposing a carbon monoxide detector within the tester.

In the tester 10 according to this invention, the first bottom wall 16 has four edges 24, 25, 26 and 27, which cooperate to form a rectangular shape. The side wall 14 projects substantially perpendicularly upwardly from the bottom wall 16 and terminates in an upwardly facing peripheral edge 20. The top member 56 is a substantially planar member having a peripheral edge 60 of rectangular shape and adapted to mate with the peripheral edge 20 of the bottom member 12. The top member 56 functions as a lid for the bottom member when the top member 56 mates with the bottom member 12.

In one embodiment, the height of the side wall 14 is preferably about 2.75 inches. The side wall 14 is continuous and forms an opposed pair of longer wall portions, defined by the edges 24 and 26, and an opposed pair of shorter wall portions, defined by the edges 25 and 27. Preferably, the longer wall portions (defined by the edges 24 and 26) are about 9.5 inches long, and the shorter wall portions (defined by the edges 25 and 27) are about 6.375 inches long. Of course, the carbon monoxide detector tester 10 may be any other shape that does not deviate from the objects of the invention. Additionally, the rectangular design promotes ease of stacking multiple testers when not in use.

While the tester is shown as comprising a bottom member 56, which forms a chamber, and a planar lid which closes onto the bottom member, the top and bottom members could be symmetrical and mirror images of one another.

The hinge member 62 hingeably connects the top member 56 to the bottom member 12. The hinge member 62 is generally axially extending and of reduced cross-section to enable the lid to flex relative to the bottom member 12. As shown, the hinge member 62 has an upper portion 64 that is attached to the top member 56, proximate to the peripheral edge 60, and a lower portion 66 that is attached to the bottom member 12, proximate to the peripheral edge 20.

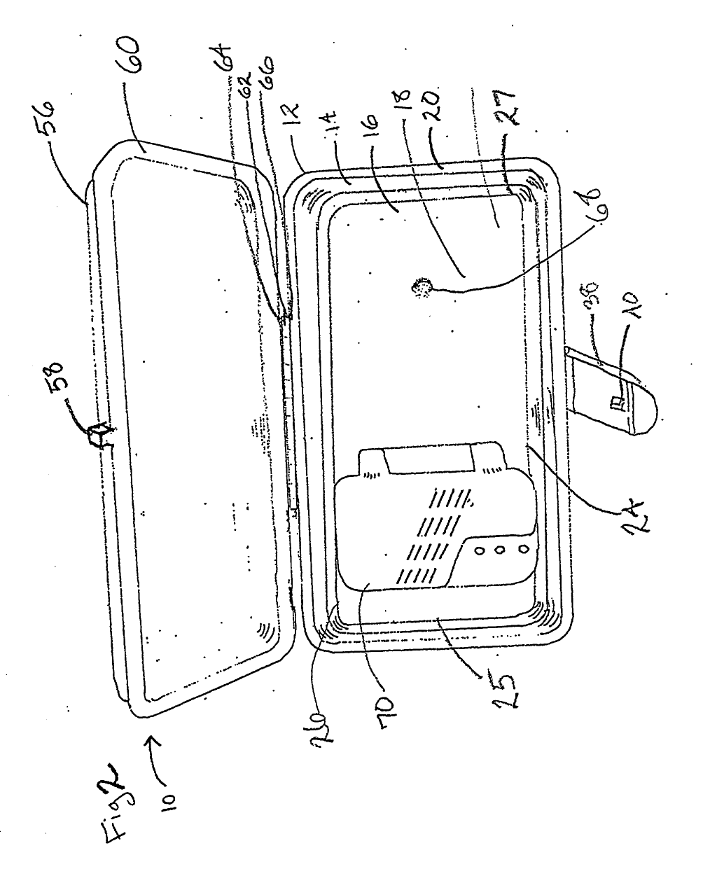

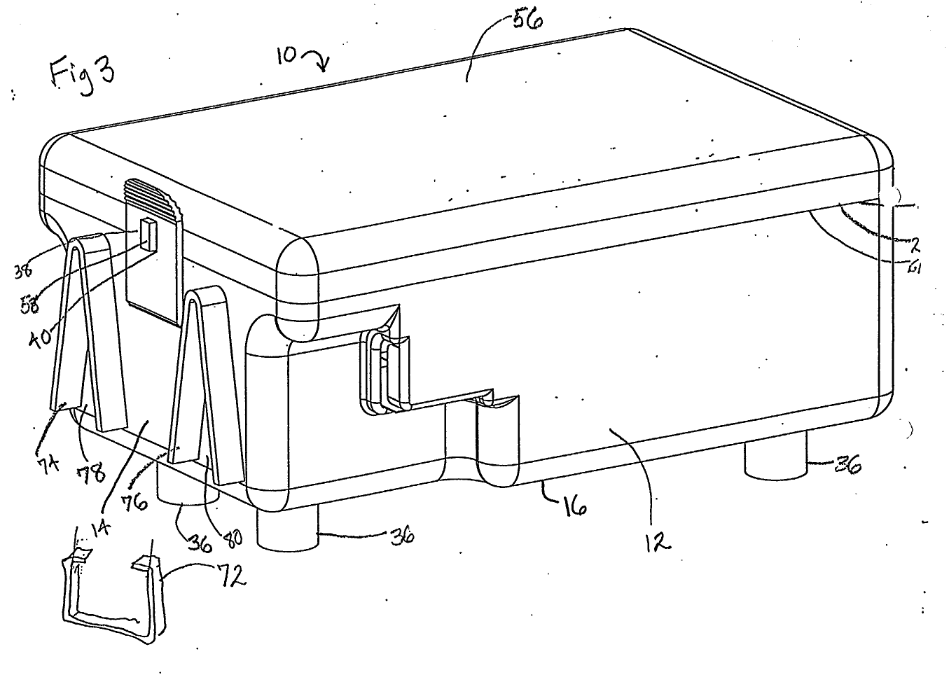

In a second embodiment shown in FIGS. 2-3, the tester is substantially the same as the tester of the first embodiment and further comprises a tab 58 on the top member 56 and a clasp member 38 on the bottom member 12, the tab 58 being adapted to interlock with the clasp member 38. The tab 58 is integrally, fixedly, formed with the top member, generally of rectangular cross-section, and projects outwardly from one of the longer wall portions of the lid 56. The clasp member 38 is integrally formed with the bottom member 12 and extends outwardly from the first side wall 14. The clasp member 38 includes a slot or keyhole 40 sized to receive the tab 58 in a friction retaining fit. The clasp member is rotatable about its attachment to the bottom member and rotates into retaining fitment with the tab 58, wherein to secure the top member to the bottom member 12.

As shown in FIG. 3, an airtight seal 61 is provided between the top member 56 and the bottom member 12 and the storage compartment 18 when the tab 58 is forced downwardly and into interengagement with the slot 40 in the clasp member 38. The peripheral edges 60 and 20 are forced into mated engagement with one another, form an airtight sealed closure therebetween, and an airtight closure about the carbon monoxide detector 70 and the carbon monoxide emitting material 68 in the storage compartment 18.

As shown in FIG. 3, the tester 10 may additionally comprise a handle 72 for transporting the tester 10. The handle 72 is preferably removably attached to the tester 10 in any suitable manner, including male/female connections, snaps, tongue and groove, etc. The handle 72 is easily detachable from the tester 10 and is preferably formed of rigid plastic strong enough to support the weight of both a carbon monoxide detector 70 and a carbon monoxide emitting material 68.

As shown, the handle 72 is connected to a pair of triangular mounts 74 and 76 fixedly attached to an outside portion of the first side wall 14 of the bottom member 12. The handle 72 is adapted to securely fit into two recesses 78 and 80 formed within the triangular mounts 74 and 76, respectively. In practice, the handle 72 is snapped into the recesses 78 and 80 of the mounts 74 and 76, respectively, by slidably engaging the handle 72 to removably fix the handle 72 to the tester 10. Likewise and in reverse manner, the handle 72 may be unseated from its corresponding recess 78 and 80 with a suitable force to overcome the frictional connection, thereby removing the handle 72 from the tester 10.

Optionally, as shown in FIG. 3, the first bottom wall 16 may have a plurality of feet 36 fixedly attached to the underside of the first bottom wall 16 for supporting the tester 10 when the tester 10 is seated on a horizontal surface.

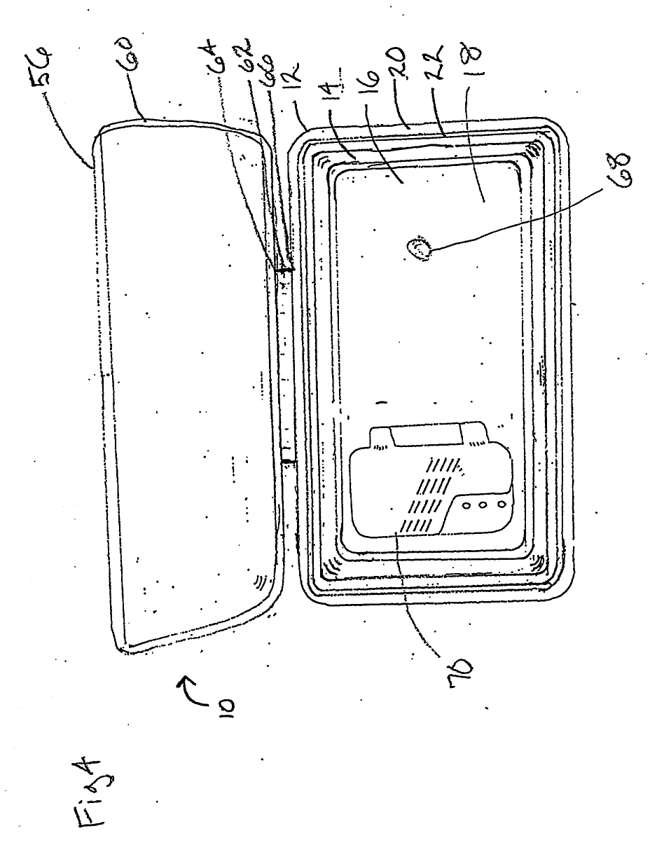

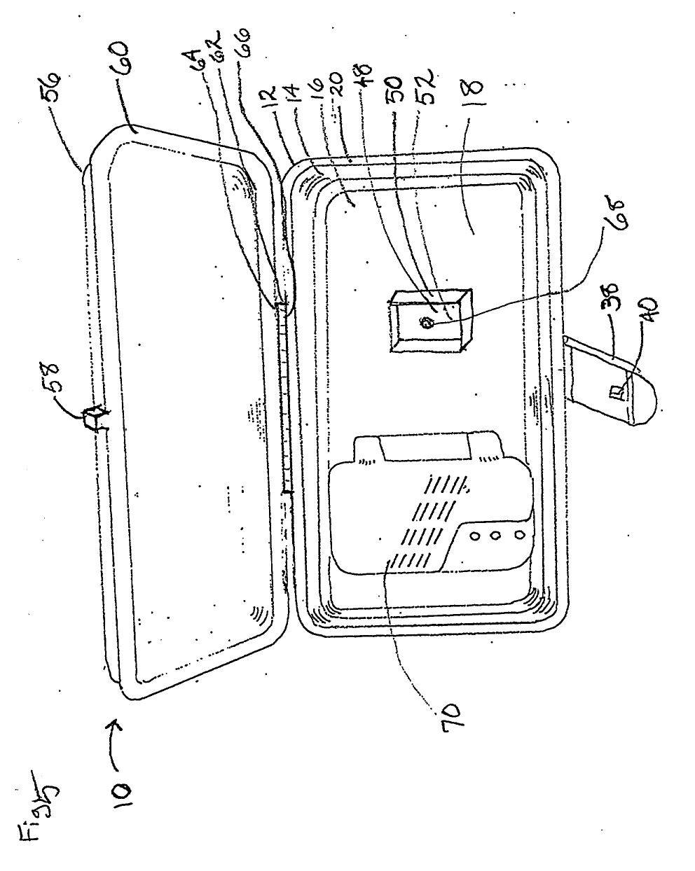

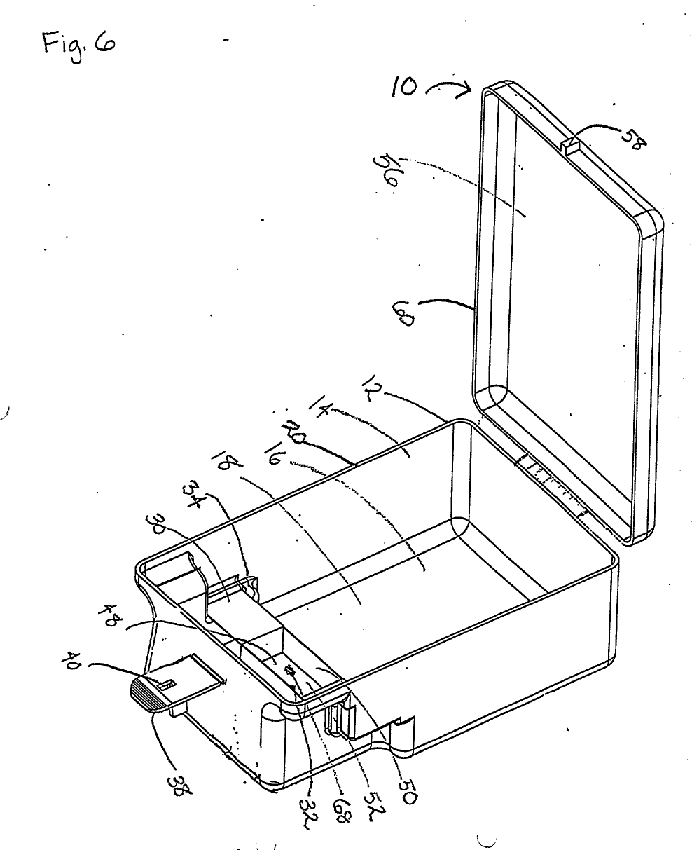

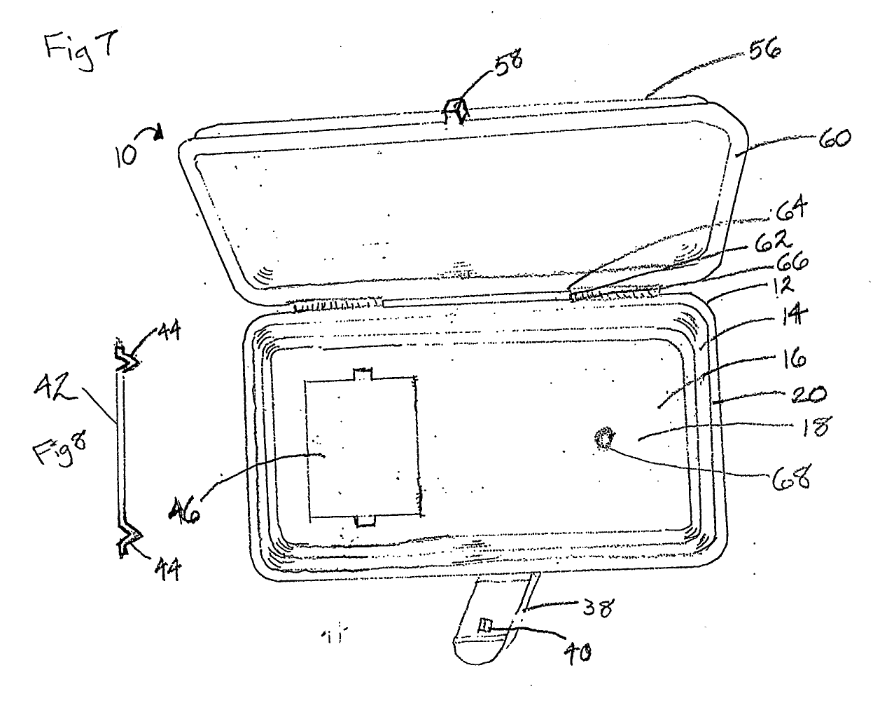

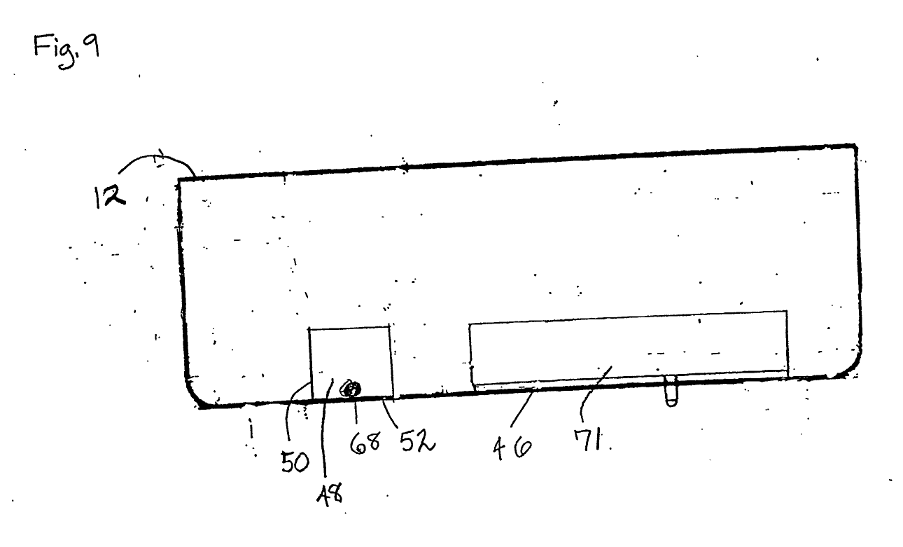

In a third embodiment shown in FIG. 4, the tester 10 is substantially the same as the tester of the first embodiment, however, the bottom member further comprises a groove 22 formed within the peripheral edge 20 of the first side wall 14, the groove being adapted to receive the peripheral edge 60 of the lid or top member 56. An airtight seal is formed between the peripheral edge 60 of the top member 56 and the peripheral edge 20 and the groove 22 of the bottom member when the groove 22 receives the peripheral edge 60 of the top member.

In the fourth embodiment shown in FIG. 5, the tester is substantially the same as the tester of the second embodiment, and further comprises a second and separate storage compartment 48 for storing the carbon monoxide emitting material 68. The storage compartment 48 is provided within the first storage compartment 18 and includes (a) a second side wall 50, and (b) a second bottom wall 52. The second storage compartment 48 is in the shape of an upwardly open box having a rectangular design to provide for easy insertion of the carbon monoxide emitting material 68. However, the storage compartment 48 may be shaped otherwise, such as in the form of a cylinder.

The second storage compartment 48 may be attached to the bottom member 12 by fixedly attaching the second bottom wall 52 to the first bottom wall 16 by conventional methods such as gluing or riveting.

Alternatively, in lieu of having the separately formed second storage compartment 48 for storing the carbon monoxide emitting material 68, as described above, the second storage compartment 48 may be integrally formed with the first storage compartment 12. In such arrangement, the second bottom wall 52 is omitted and replaced by the first bottom wall 16 of the bottom member 12, and the second side wall 50 extends upwardly from the first bottom wall 16, sharing the first bottom wall 16 as a common floor with the first storage compartment 18.

Additionally, in some applications, the second storage compartment 48 could include elimination of the second bottom wall 52, and gluing or otherwise attaching the lower edge of the second side wall 50 to the first bottom wall 16.

In a fifth embodiment shown in FIG. 6, the tester is substantially as the tester of the fourth embodiment, however, the bottom member 12 further comprises a horizontal shelf portion 34. Preferably, the shelf portion is integrally formed with the first side wall 14, projects inwardly towards the first storage compartment 18, and defines a stop for a lid

Additionally, the second storage compartment 48 further comprises a lid 30, and a latch 32. The lid 30 moves between a closed first position for closing the storage compartment 48, and an open second position for exposing or otherwise permitting placement of the carbon monoxide emitting material 68 in the storage compartment 48. In the first position, the latch 32 receives the lid 30 and the lid 30 closes the upward opening of the second storage compartment 48 whereby to secure the carbon monoxide emitting material 68 in the storage compartment 48. In the second position, the lid 30 is in the open position and engages, and is preferably detained by or held in, the horizontal shelf portion 34 of the bottom member 12. Further, when the lid is in the open position, the top of the storage compartment is uncovered and the carbon monoxide emitting material 68 may be placed therein or is exposed. Upon ignition of the material 68, the carbon monoxide gas is discharged from the second storage compartment 48, and passed into the interior of the first storage compartment 18 which houses the carbon monoxide detector 70.

In the sixth embodiment shown in FIGS. 7-9, the tester is substantially the same as the tester 10 of the second embodiment, however the first storage compartment 18 further comprises a removable access panel 42 that is secured within an opening 46 formed within the first bottom wall 16. When the removable access panel 42 is removed from the opening 46, a carbon monoxide detector 71 of the type designed to plug into an electrical outlet may be inserted into the first bottom wall opening 46.

Preferably and according to this invention, the means for securing the removable access panel 42 to the first bottom wall opening 46 comprises a snap clip 44. The snap clip 44 secures the removable access panel 42 within the first bottom wall opening 46 when the snap clip 44 is not compressed, but when the snap clip 44 is compressed, the snap clip 44 allows for easy removal of the removable access panel 46 from the opening 46 of the first bottom wall 16. Other means for securing may be used, such as a latch, a clasp, etc.

In practice, the top member 56 is opened thereby exposing the storage compartment 18. The carbon monoxide detector 70 and the carbon monoxide emitting material 68 are placed within the first storage compartment 18. The carbon monoxide emitting material 68 is then ignited thus allowing the material to give off a carbon monoxide gas, which is passed to the carbon monoxide detector 70.

The test may be performed by using either the carbon monoxide detector 70 or the carbon monoxide detector 71 designed to plug into an electrical outlet. If the carbon monoxide detector 71 is used, the removable access panel 42 is first removed, the detector 71 is placed within the opening 46, and then the detector 71 is plugged into an electrical outlet. The method of using the tester after plugging the detector 71 into an electrical outlet is the same as the method used for detecting the operability of detector 70 as described herein below.

Optionally, if the tester comprises a second storage compartment 48, then the second storage compartment lid 30 is opened to engage the horizontal shelf portion 34 of the bottom member thus allowing the carbon monoxide emitting material 68 to be placed within the bottom member 12. Next, carbon monoxide emitting material 68 may be ignited and thus allowing carbon monoxide to be emitted for presentation to the detector 70 within the bottom member 12.

Immediately after igniting the carbon monoxide emitting material 68, the top member 56 is mated with the bottom member 12 to form a closure in a manner described herein above thus allowing a concentrated amount of carbon monoxide gas to flow from the carbon monoxide emitting material 68 to the carbon monoxide detector 70. Depending upon the sampling time Tₛ for the carbon monoxide detector 70 to sample carbon monoxide emitted from the carbon monoxide emitting material 68, a properly functioning carbon monoxide detector will signal an alarm upon sensing the carbon monoxide after a predetermined length of time, Tₛ. If an alarm is signaled by the detector 70 after Tₛ time passes, then the carbon monoxide detector is functioning properly. If no alarm signals after Tₛ time passes, the carbon monoxide detector tester has properly performed its function by indicating that the carbon monoxide detector has failed to function properly. Upon completion of the test, the carbon monoxide detector may be removed.

If the tester includes the second storage compartment 48 having a lid 30, then the lid 30 may be secured by the latch 32 to securely store the carbon monoxide emitting material 68 until the next test is performed.

It is to be appreciated from the preceding that there has been described herein a carbon monoxide detector tester having means for testing a carbon monoxide detector in a cost efficient and simple to use and expedient manner.

What is claimed is:

1. A tester for testing the functionality of a gas detector, said tester comprising: a housing that defines an accessible airtight interior chamber, said interior chamber being subdivided and including a first region for receiving a gas detector to be tested, a second region for receiving an ignitible gas emitting substance, and a third region defining an air flow path that extends between said first and second regions for communicating a sample of gas emitted from the ignited substance.

2. The tester as claimed in claim 1, wherein said housing includes first and second housing members which are mateable to form said interior chamber, and further comprising means for releasably latching the housing members together in sealed airtight relation and permitting the members to be unlatched and separated, at least in part, wherein to permit said detector and said material to be placed within said interior chamber.

3. The tester as claimed in claim 2, wherein said second region comprises a discrete storage compartment for receiving and storing the gas emitting substance, said storage compartment separate and spaced apart from said detector.

4. The tester as claimed in claim 3, wherein: said first housing member comprises a bottom wall and an outer sidewall projecting upwardly from said bottom wall; said second housing member is closable about the upward projection of said outer sidewall whereby to form said interior chamber; and said storage compartment comprises a tubular wall having opposite end portions, and means for securing one end portion of the tubular wall to the bottom wall such that the other end portion is proximate to the second housing member and in communication with said third region.

5. The tester as claimed in claim 4, comprising a closure member for removably closing the other end portion of said tubular wall whereby to form a tubular storage compartment that is closed and denies access to said compartment when said closure member lid is in a first position and is open and permits access to the compartment when said closure member is in a second position.

6. The tester as claimed in claim 5, wherein said housing is comprised of a material that enables an audible signal in the interior chamber to be heard outside of said housing member, and said carbon monoxide detector is adapted to sample the gas discharged into the interior chamber from the gas emitting material in the storage compartment and, if properly functioning, to generate an audible alarm signal upon detecting the presence of a predetermined gas.

7. A carbon monoxide detector tester comprising:
a housing member, said housing member including bottom and top members, said bottom member having a bottom wall and a first peripheral edge, said members being adapted to mate with one another with the respective peripheral edges sealingly abutted together whereby to form an airtight seal and interior chamber for receiving a carbon monoxide detector;
a separate storage compartment in said interior chamber for storing an ignitable carbon monoxide emitting material suitable for emitting carbon monoxide in the interior chamber;
a tab and a clasp member connected to one and the other of said members, the tab being engaged by said clasp member for latching the members together; and
a hinge for hingeably connecting the top member to the bottom member wherein to enable the members to be separated and access to the interior chamber.

8. The carbon monoxide detector as claimed in claim 7, wherein
said carbon monoxide detector is adapted to sample the gas discharged into the interior chamber from the gas emitting material in the storage compartment and, if properly functioning, to generate an audible alarm signal upon detecting the presence of a predetermined gas, and
at least one of said top and bottom members of said housing is comprised of a material that enables an audible signal in the interior chamber to be heard outside of said housing member when said top and bottom members are sealed in airtight relation.

9. A carbon monoxide detector tester comprising:
(a) bottom member, the bottom member having
(i) a first side wall, and
(ii) a first bottom wall;
(b) a top member, the top member adapted to mate with the bottom member; wherein the top and bottom members member matingly connect with one another to form an airtight interior chamber;
(c) means for storing a carbon monoxide detector within the bottom member;
(d) means for storing a carbon monoxide emitting material within the bottom member; and
wherein the first side wall of the bottom member and the first bottom wall of the bottom member cooperate to form a first storage compartment, the first storage compartment defining means for storing a carbon monoxide detector within the bottom member and the means for storing a carbon monoxide emitting material within the bottom member.

10. The tester of claim 9, further comprising:
(a) a peripheral edge formed on the first side wall of the bottom member; and
(b) a peripheral edge formed on the top member adapted to mate with the bottom member first side wall peripheral edge;
wherein the bottom member first side wall peripheral edge cooperates with the top member peripheral edge to form a pressure-fit seal when the bottom member mates with the top member.

11. The tester of claim 10, further comprising:
(a) a tab integrally formed within the top member and extending outwardly from the top member, the tab adapted to mate with a clasp member; and
(b) a clasp member disposed on the bottom member, the clasp member having a slot formed within for receiving the tab formed within the top member, the clasp member extending outwardly from the first side wall and being rotatable for receiving the tab when the bottom member first side wall peripheral edge mates with the top member peripheral edge.

12. The tester of claim 10, wherein the bottom member first side wall peripheral edge further comprises a groove adapted to receive the top member peripheral edge.

13. The tester of claim 10, further comprising:
(a) at least one hinge member being operable to hingeably connect the top member to the bottom member, the hinge member having a first end portion attached to the top member peripheral edge and a second end portion attached to the bottom member first side wall peripheral edge.

14. The tester of claim 9, further comprising means for storing a carbon monoxide emitting material, said means for storing comprising::
(a) a second side wall, and
(b) a second bottom wall, wherein the second side wall and the second bottom wall cooperate to form a second storage compartment for storing a carbon monoxide emitting material, and wherein the second bottom wall is fixedly attached to the first bottom wall of said bottom member.

15. The tester of claim 14, wherein the second storage compartment further comprises:
(a) a lid attached to said second side wall, and
(b) a latch for removably engaging said lid, said latch movable between first and second positions;
wherein the lid engages the latch when said latch is in said first position whereby to secure a carbon monoxide emitting material within said storage compartment, and said lid is disengaged from the latch to expose the carbon monoxide emitting material within the first storage compartment when said latch is in said second position.

16. The tester of claim 15, wherein said bottom member further comprises a horizontal shelf portion, said shelf portion projecting inwardly from the first side wall and towards the first storage compartment whereby to define a stop for the lid.

17. The tester of claim 9, wherein the bottom member further comprises a removable access panel formed within the first bottom wall such that when the removable panel is removed, an opening is formed within the first bottom wall for receiving a carbon monoxide detector, said detector having electrical connection prongs for plugging the carbon monoxide detector into an electrical outlet.

18. The tester of claim 9, further comprising:
means for supporting the tester when the tester is in a horizontal position, wherein said means for supporting the tester comprises a plurality of feet fixedly attached to the bottom member on an underside portion of the first bottom wall.

19. The tester of claim 9, wherein the bottom member further comprises
(a) a handle, and
(b) a pair of mounts for receiving the handle, said mounts being fixedly attached to the bottom member and having recesses therewithin for receiving the handle, said handle removably engaging the recesses in the mounts.

20. A method of using the carbon monoxide detector tester of claim 9, comprising the steps of:
(a) opening the carbon monoxide detector tester to receive a carbon monoxide detector and a carbon monoxide emitting material;
(b) removably placing a carbon monoxide detector and a carbon monoxide emitting material within the first storage compartment of the opened carbon monoxide detector tester, the detector being adapted to generate an alarm signal if functioning properly;
(c) igniting the carbon monoxide emitting material to allow the carbon monoxide emitting material to emit carbon monoxide;
(d) securely enclosing the carbon monoxide detector and the carbon monoxide emitting material to allow the carbon monoxide detector to receive the carbon monoxide; and
(e) detecting an alarm signaled by the carbon monoxide detector when the carbon monoxide detector receives the carbon monoxide.

21. The method of claim 20 further comprising the step of removably placing the carbon monoxide emitting material within a second storage compartment disposed within the first storage compartment of the carbon monoxide detector tester.
